(19) United States
(12) Patent Application Publication
(10) Pub. No.: US 2005/0071170 A1
(43) Pub. Date: Mar. 31, 2005

(54) Dissection of utterances into commands and voice data

(76) Inventor: Liam D. Comerford, Carmel, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/674,573

(22) Filed: Sep. 30, 2003

(51) Int. Cl. G10L 11/00

(52) U.S. Cl. 704/275

(57) ABSTRACT

A system and method for recognizing commands and voice data in a same utterance includes decoding voice data to identify words or phrases in an utterance and determining those word or phrase acoustic boundaries within the utterance voice data. One or more commands are found in the utterance and segments based on the acoustic boundaries of the one or more commands are labeled. Portions of the utterance that are not part of a command are retained as voice data. The one or more commands found in the utterance are executed. Command execution may include changing recognizer vocabulary to facilitate recognizing the words or phrases in the residue voice data or the residue voice data may be retained for other uses.

### BACKGROUND

1. Field of the Embodiments

Aspects of the present disclosure relate to speech recognition, and more particularly to a system and method for processing speech to support mixing commands and acoustic data representing speech in a single utterance.

2. Description of the Related Art

Spoken Language user interfaces are strongly modal in the sense that discrete utterances made by a person are treated either as acoustic data (which may be retained as acoustic data but is typically decoded into text), or as commands (which are typically decoded and executed). The differences between acoustic data (digitally recorded voice sounds) treated as data and acoustic data decoded into commands may be seen, by comparing a desktop dictation system with a “voice dialer”. In the desktop system, the user's utterance sounds are decoded into text which is displayed, manipulated and stored as text data, while in a cell phone dialer (assuming the user has entered appropriate names into the cell phone's “telephone book”), the user will be able to utter a person's name and have that utterance decoded and treated as a command to look up that name and dial the associated telephone number.

In the state-of-the art, utterances comprising commands and utterances comprising data must be separate. This fact imposes a limitation on spoken-language-interface application developers and forces users of these systems to contort their interactions with the system.

### SUMMARY

A system and method for recognizing commands and voice data in a same utterance includes decoding words or phrases in an utterance and determining word or phrase boundaries within the utterance to determine which portions of the buffered electronic representation of an utterance are decodable within the current vocabulary of an Automatic Speech Recognition system (ASR or speech decoder), hence which portions of the utterance can be treated as commands (the decoded part or parts) and which portion should be treated as (possibly as yet) undecoded acoustic data.

The combination of the decoded acoustic data segments (e.g. text) is then treated as a command and the un-decoded segments are treated as data that may be utilized by the command. This combination of decodable voice commands and acoustic voice data in utterances permits more flexible and natural interactions between applications and users.

It should be understood that command execution may include changing the speech recognizer grammars (vocabulary) to facilitate recognizing the words or phrases in the residue acoustic data or the residue acoustic data may be retained for other uses.

These and other objects, features and advantages of will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a block diagram showing a system for recognizing speech in accordance with one illustrative embodiment.

FIG. 2 is a block diagram showing more detail for the illustrative embodiment of FIG. 1.

FIG. 3 is a diagram showing recognition results and alignments for an utterance.

FIG. 4 is a diagram showing recognition results and alignments for an utterance with an undecoded portion, located between two decodable segments of acoustic data representing the utterance.

FIG. 5 is a block diagram showing a first part of a program for distinguishing commands in an utterance in which utterances having a command portion comprising two parts of the utterance that surround the voice data portion of the utterance are processed.

FIG. 6 is a diagram showing recognition results and alignments for an utterance with an undecoded portion that comprises the final portion of the utterance. This portion may be decoded by changing the vocabulary of the recognition system. In this case, the command implies that a number vocabulary is an appropriate choice.

FIG. 7 is a block diagram showing a second part of a program for distinguishing commands in an utterance in which utterances with the command portion preceding the voice data portion of the utterance are processed.

FIG. 8 is a diagram showing recognition results and alignments for an utterance with an undecoded portion in which the command portion of the utterance follows the voice data portion.

FIG. 9 is a block diagram showing a third part of a program for distinguishing commands in an utterance in which utterances with the command portion following the voice data portion are processed.

FIG. 10 is a block/flow diagram showing a speech recognition system/method for another illustrative embodiment.

### DETAILED DESCRIPTION OF PREFERRED EMBODIMENTS

Aspects of the present disclosure provide a system and method by which single utterances may be used to provide both commands and voice data so that spoken-language user interfaces can be made more flexible and useful for users. Commonly spoken language interfaces manage the user's behavior so that the user's utterances (ideally) are either commands or data depending on the state of the system presenting the interface. In typical systems, uttering commands when the state of the system demands data, will leave the command undone, and uttering data when the state of the system expects commands can cause the system to do unexpected things.

In an example of a voice dialer, entering a new name into a cell phone telephone book may involve a number of steps and may need entry of both commands and data. To begin, the user may need to click several buttons to find his way to the “Enter new name” screen. Next, the user may need to type the new name and telephone number. Next the user may need to say the name to provide voice data to be compared with future utterances. The process of entering the voice data is distinct from the process of typing the new name command and entering the name and number data. Further, the interval in which the new name is spoken may be signaled to the user with a user interface artifact such as a beep sound or may be started by the user with a button press. Termination of the interval may be forced by an internal timer or by a second button event.

A speech oriented version of this process may be initiated by the user uttering a command such as “Phone book add new name” to which the telephone may reply something like “Please spell the name by speaking or typing”. The user may then speak the letters or “military alphabet” representation of the letters or type the letters in on the telephone keypad. A silence or a specific button press may signal completion. If the speech recognizer provides an “acoustic add word” feature, the user may merely be asked to say the name. The user may then be prompted to speak or type the telephone number for the new name. A telephone system might avoid the name-entry step in some cases by asking for the number first, dialing it's parent organization's information service and obtaining the name from them. It could then be confirmed by the user or filled in by the user if the service could not find the associated name. In all cases the user act of issuing commands is distinct from the user act of supplying data.

Each of these examples are structured by the need that a command be received to prepare the system to receive data. In aspects of the present disclosure, commands and data may be combined in a single utterance. Thus, the act of placing a new name and number (Jack Smith at 666-1234, for example) in the phone book could be reduced to uttering “Add Jack Smith to my phone book. His number is six six six, one two three four” or similar procedures or utterances. This may be followed by confirmation and, if needed, correction of the entry.

Each of these two utterances can be dissected into command and data parts. The first includes the command “Add to my phone book”. It explicitly identifies an action, “Add to”, and a target for that action, “my phone book”. It also includes acoustic data having the non-textual information about how the name “Jack Smith” sounds when uttered.

The second utterance includes a subtler, implicit command. The part of the utterance “His number is” is best treated as a command to change the recognition vocabulary to a number recognition vocabulary. The voice data within the utterance is the sound of the spoken “six six six, one two three four” which should be processed in conjunction with the number recognition vocabulary. Other variations on the treatment of utterances including both command and data segments, fall within the scope of the present disclosure, and are too numerous to recite, and will be understood to those of ordinary skill in the art.

The examples, using separate commands and data acts, may have created such a vocabulary change command as part of a “directed dialog” prior to prompting the user to “please say the number.” In the present case, the user is not commanded to do anything by the computer. The partial utterance “His number is” can be decoded into a vocabulary change command and the partial utterance “six six six, one two three four” is voice data to be decoded into numbers. Note that this differs significantly from asking the user for the number in that the words “His number is” and equivalent phrases would not and should not be included in a number-recognition vocabulary because doing so would degrade recognition accuracy.

In the example for entering names in a speech activated telephone dialer, making the interaction with the user simpler and more completely user-driven increases the convenience of the voice interface. A method for dividing utterances into commands and voice data may provide other benefits as well. For example, people do not always produce perfect information-containing utterances. Dislocutions, inadvertent noises and social components may also be uttered. For example, a user may have said “His number is . . . wait a second . . . “six six six, one two three four” or “His number is six six six, cough, cough, one two three four” or “His number is six one five, no, six six six, one two three four.” Processing the “data” part of the utterance separately from the “command” part also permits reprocessing the voice data to extract the maximum amount of useful information without forcing retries.

In one case, the data (6661234) can be obtained by iteratively reducing the length of the voice data from its start and reprocessing it through an automatic speech recognizer until the shortest length of audio that yields seven digits can be found.

In another case, processing from the beginning in yields a maximum length digit string of four digits (1234) at the end of the audio data. Processing from the point in the audio at which that string begins, toward the beginning of the voice data yields a maximum length string of three digits (666). Taken together in order, they satisfy the criterion for a telephone number.

In the yet another case, processing for maximal length number strings yields the correct 6661234 sequence on the first sweep. In each of these cases, a good user interface design would confirm the constructed number.

Exemplary embodiments have been described herein in the context of a small, frequently connected, embedded computing system (a cell phone). However, this should not be construed as limiting the scope of the present disclosure since one of ordinary skill in the art in view of this disclosure would be able to apply the methods and systems disclosed herein in other devices and applications without departing from the spirit of the invention. In a system comprising a telephone and a remote Interactive Voice Response based service, for example, the same techniques may be applied to finding and retaining segments of a customer's speech that constitute the verbal agreement or specify the goods and services ordered. This would permit both verification of Automatic Speech Recognizer (ASR) decoding of speech to assure an order includes the correct items, and evidentiary support for the fact that an agreement was entered into.

In another example, in a speech aware PDA, the utterance “remind me to call Jack Smith at three PM” could be divided into the command “remind me at three PM” and the speech data “call Jack Smith.” A correctly programmed PDA would then, at three PM, say “you asked me to” (using text to speech generation) “call Jack Smith” (playing back the speech data). In general, using this technique reduces the size of automatic speech recognition vocabularies, improving recognition, by allowing some parts of the user utterance to fall completely outside the vocabulary.

It should be understood that the elements shown in the FIGS. may be implemented in various forms of hardware, software or combinations thereof. Preferably, these elements are implemented in software on one or more appropriately programmed general-purpose digital computers or electronic devices having a processor and memory and input/output interfaces.

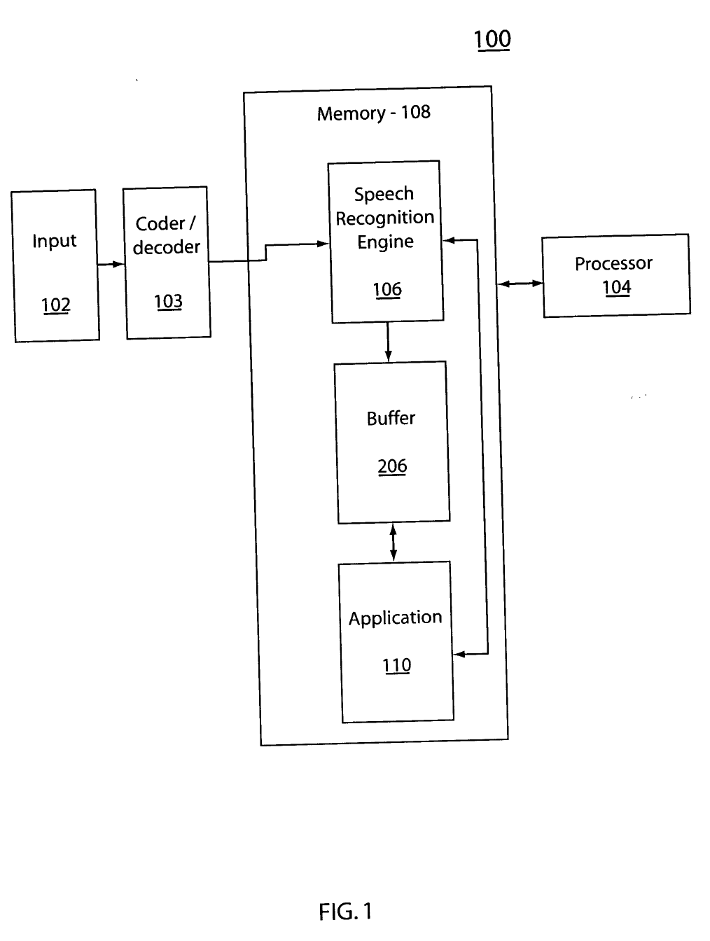

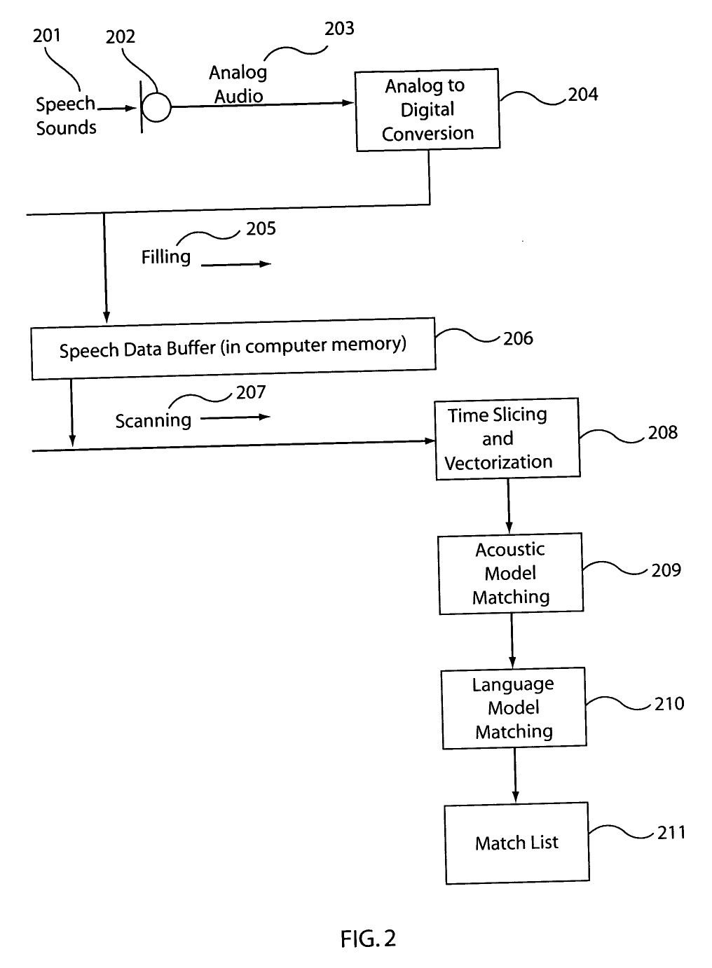

Referring now to the drawings in which like numerals represent the same or similar elements and initially to FIG. 1, a system 100 includes an acoustic input 102. A coder/decoder 103 is employed to convert the input from an acoustic signal into a digital signal. Input signals are processed to decode those segments of acoustic data that include words and phrases in the active vocabulary of the ASR 106. Exemplary embodiments include an Automatic Speech Recognizer (ASR) or engine 106 as a component or software function preferably stored in memory 108. The ASR 106 decodes acoustic data providing data to the application which both represents the decoding (text) and the “alignments” or locations in the acoustic data in buffer 206 corresponding to the parts of the decoded text (see also FIG. 2). The alignment data specifies the beginning and ending locations in buffer 206 of each recognized word.

ASR's may be designed to accept buffers of continuous speech data as input. Such ASR's (for example IBM VIA VOICE®) process that input by a sequence of steps that complete by providing a “best guess” text representation of at least some of the input utterance. Memory 108 preferably includes one or more applications programs 110, can accept commands from the ASR (or keyboard or other sources) and which may utilize, the acoustic data found in the Buffer 206. The ASR and application program processing is provided by a processor 104. The software process incorporated in the application to identify commands and data within an utterance will be described in further detail herein.

Referring to FIG. 2, exemplary steps employed for performing recognition by an ASR are as shown. Speech sounds 201 created by a user or other source are intercepted by a microphone 202, which converts speech sounds 201 into an analogous electrical signal 203. The analog signal 203 is received by an analog-to-digital converter circuit 204 which coverts the analog signal into a corresponding digital representation by sampling, for example, at some sampling rate greater than twice the bandwidth of the analog audio to be processed and converting the amplitude of each sample in turn into a digitally represented numerical value. Appropriate analog to digital converters are generally referred to as “CODECs”. These devices also code the digital representation of the analog speech signal in standard format accepted by the ASR.

A succession of values is placed (205) in sequential order into a Speech Data Buffer 206. In some implementations the Speech Data Buffer 206 may be implemented as a circular buffer by means familiar to those skilled in the art of computer programming. The Speech Data Buffer 206 is scanned 207 by reading its contents sequentially but so that the buffer position being scanned 207 does not pass the buffer position being filled 205. Digital audio data scanned 207 from the audio buffer 206 is collected in time slices in block 208 comprising a time duration of, e.g., one tenth of a second per slice. For audio sampled at a 44 kHz rate for digitization in block 204, this will include 4400 values for one second of acoustic data.

These values are represented as vectors in block 208 with high dimensionality by numerically transforming the data by means that preserve and accentuate the features that characterize the properties of speech as opposed to other types of sound. Sequential collections of these vectors are then compared in block 209 with acoustic models of words in the recognition vocabulary. A perfect match is very unlikely so several different strings of words may be sufficiently acoustically similar to the input and processed speech to be confusable by the recognizer. For example, “I know how to recognize speech” is confusable at the acoustic level with “I know how to wreck a nice beach.” Similarly, in the phrase “It takes two to tango too” each of the words two, to and too are acoustically confusable. This problem is managed by a Language Model 210 which compares the members of the collection of acoustically confusable match results from block 209 with a language model to determine which, hopefully single, acoustic match result may be a real human utterance. This result or results is/are provided as the output of the recognition process in the form of a match list 211.

In various implementations of such technology, the time information for the acoustic data has been preserved through the recognition process so that, generally for error correction and/or acoustic model training, the portion of the speech buffer 206 which includes the audio data corresponding to the recognized word(s) in the match list 211 is available for the length of a recognizer use session. “Small” vocabulary recognition engines may also be built along similar lines. Small vocabulary recognition engines may lack the Language Model 210 stage of processing, hence place more reliance on the Acoustic Model 209. Both large and small vocabulary recognizers often provide a means for specifying the vocabulary by supplying a “grammar” to the recognizer 106 (FIG. 1). In a small vocabulary recognizer the grammar may play the role of a language model. Many different grammar notation systems are in common use. For the following examples, the Bachus-Naur form (BNF) typical of IBM speech recognition products will be illustratively used.

BNF grammar notation offers a concise and unambiguous way to specify phrases for possible recognition to an automatic speech recognizer 106. In FIG. 2, a simple grammar and the phrases it generates are shown for illustrative purposes.

BNF:

<root> = I want <fruit> | Do you have <fruit>.
<fruit> = an apple | a banana | an orange | a peach.

A grammar is spoken of as “generating” phrases. The phrases that are consistent with this grammar, hence generated by it are:
I want an apple.
I want a banana.
I want an orange.
I want a peach.
Do you have an apple.
Do you have a banana.
Do you have an orange.
Do you have a peach.

The superiority of a BNF notation to exhaustive enumeration is apparent. It should be understood however, that when an ASR 106 using a grammar specification of its vocabulary recognizes a phrase, that phrase will be one of the phrases generated by its grammars. It should further be understood that the property of retaining the speech buffer alignment information is in no way compromised by the use of grammars to specify the ASR vocabulary.

By employing the boundary identification methods of the present disclosure, many grammars may be employed, which add to the convenience of a user, and provide significant additional possibilities in improving the ease of use of many electronic devices. These grammars are preferably employed to extract commands from utterances and identify remaining portions of the same utterance as acoustic voice data. These grammars may include, for example, a form for extracting information in an order or verbal contract. In one example, for placing an order, a user may state “purchase five of catalog number 345”. The command “purchase” would be extracted using the grammar and the acoustic data segment “five of catalog number 345”, which may be decoded by iteratively employing a special vocabulary and retained for verification purposes.

Other command grammars employed with acoustic data in a same utterance may include a form for reminding a user to perform a task at a particular time. For example, “remind me at 4 PM to call Jack”. A grammar for “remind me at” would be employed and “to call Jack” would be stored as data or decoded by a different vocabulary. Grammars may also be included to extract a maximum length meaningful segment under interruption or silence conditions. For example, “call 666 ‘cough’ (pause) ‘cough’ 1234”. Grammars could exist for determining a group of numbers in this case seven, suggested by the command “call” to execute the command while extracting out the coughs and silence segments.

The relationship of the alignment information to the user utterance will now be considered. Referring to FIG. 3, a timeline 301 shows significant events of an utterance and relationships between those events and alignment data.

Crosshatched boxes correspond to segments of audio that do not contribute data to the decoding. FIG. 3 illustrates several phenomenon related to the alignment of segments of a continuous stream or buffer of audio data and the time at which speech recognition software may infer a start or end of a word in an utterance. Most automatic speech recognition systems (ASR) will demonstrate increased recognition error rates if the start of the audio to be decoded is too near to the start of the first or end of the last word. Thus, in the diagram above, a period without speech is shown before the word “I” and after the word “apple”. The word “I”, comprising the vowel sounds “ah ee”, has relatively indistinct boundaries so an ASR system may attribute somewhat different values to the start and duration of the utterance than a person would.

In the case of the utterance “want”, the starting boundary sound “oo a” has properties similar to “I” but the terminal boundary sound, the plosive “t”, provides a sharper boundary. A large gap may exist between the distinctly pronounced “t” of “want” and the “a” of “an”. This interval is produced by the speaker (soundlessly) repositioning the vocal apparatus. If, on the other hand, the speaker were to run the words “want” and “an” together, the blended pronunciation may more nearly resemble “wantdan apple”. The boundary provided by the terminal “t”, however, remains distinct and so can be located accurately in time. In the blending “anapple”, the boundary between “an” and “apple” is indistinct and does not require repositioning the tongue or the lips. Thus, the boundaries between words as understood by people and ASR systems may differ somewhat so that the ASR detected boundaries may be considered to be approximations.

Some phonemes will provide un-blurred boundaries while others, particularly in the case of blending, will not. In general, the distinction between the machine-derived boundary and the human perception of the boundary is not so great that humans find it hard to understand the audio segment delineated by an ASR as the data decoded into a given word, as that word.

Returning to the example of creating a phone book entry, it is reasonable to believe that the number of names of people or the number of street names in addresses is vast. ASR's of the scale that make vocabulary definition through BNFs useful cannot be expected to include all the names a person may encounter, or to recognize the pronunciation of the name by the owner of the telephone. This problem can be overcome by ASR's that allow additions to their vocabularies in the form of an acoustic sample of the new word. Thus, if an utterance such as “Add Jack Smith to my phone book” can be divided to provide the acoustic sample of the user saying “Jack Smith”, that acoustic sample could be used to add a “word” to the vocabulary of the recognition system.

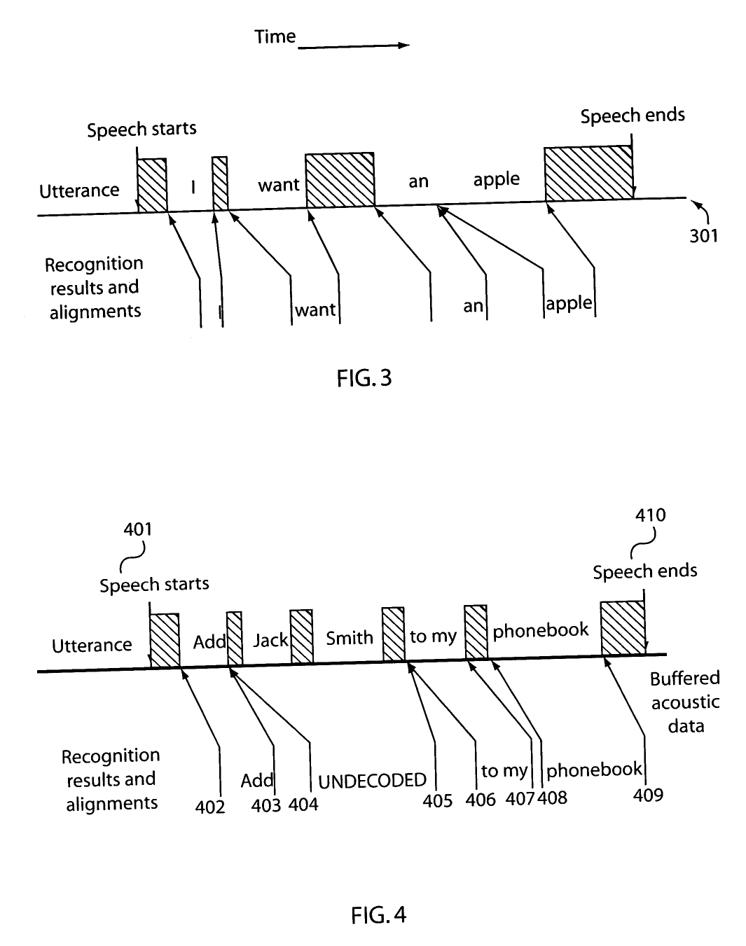

The boundaries of the utterance “Jack Smith” or any other utterance in the same sequential position can be obtained by using two grammars with an ASR that returns alignments. A set of such grammars is shown in FIG. 4.

Numbers attached to words by colons are “labels” in the following example. These numbers are part of the decoded data that is returned by a grammar based ASR, but are not uttered by the user.

Case 1:

// first grammar
<root> = Add:1000 | Please add:1000 | Delete:1000.
// second grammar
<root> = to:1001 my <target>
<target> = phonebook | address book | telephone book.

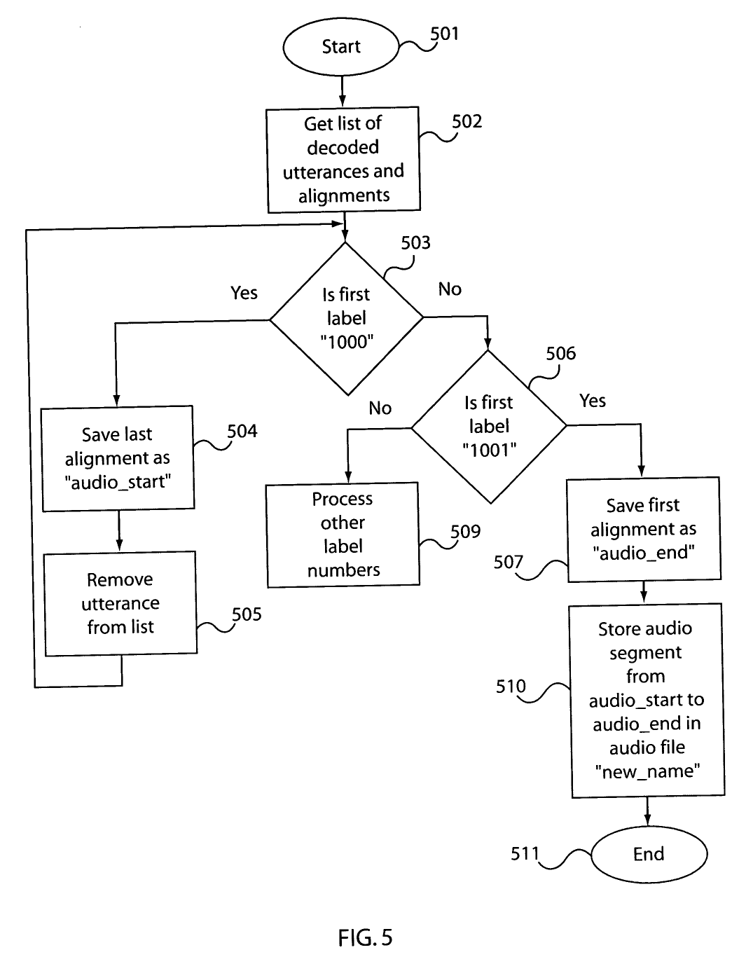

Referring to FIG. 4, elements 401 and 410 represent the beginning and ending of the buffered acoustic data. These markers correspond to closing 401 and opening 410 a microphone button (e.g., a physical switch). Here, the alignments of the microphone button operations (401, 410) and the alignments for the utterances (402, 403, 404, 405, 406, 407, 408, 409) are available to programs by means of procedure calls specifying the word whose alignment is requested. Thus, the utterances (“Add:1000” and “to:1001 my phonebook”) returned by the ASR could be processed to obtain the audio data corresponding to the period between time 405 and time 406 as illustrated in FIG. 5. The utterance as shown is the sequence of sounds produced by the user. The line buffered acoustic data represents a buffer including an electronic representation of those sounds. The recognition results and alignments (shown as arrows) are the output of the ASR.

In case 1 illustrated above, even labels that are between 1000 and 1999 and odd labels between 1000 and 1999 have been chosen by the user interface designer or have been established by convention to indicate that the utterances serve as, respectively, starting and ending brackets that surround a region of audio that is to be saved as audio data rather than decoded into text. In subsequent examples, the labels in the 2000-2999 range will be used to indicate that the utterance is a starting marker for a region of audio data and labels in the 3000 to 3999 range will be used to indicate that the utterance is an ending marker for a region of audio data.

Continuing with FIG. 5, upon return of a decoded audio data buffer by the ASR, a software function or program illustrated in FIG. 5 is executed beginning at start 501. Next, the set of text decodings of the buffered audio data is fetched and the alignments of the decoded audio and the speech start (401) and end (410) times are retrieved in block 502. The first decoded utterance is examined in block 503 to determine whether or not the label 1000 is associated with the last word of the first decoded string. If the label 1000 is found, then the variable “audio_start” is set equal to the ending alignment of the word labeled “1000” in block 504.

Next, the utterance that has been examined is removed from the list of utterances or otherwise marked or recorded as having been processed in block 505. Processing now returns to block 503. Here, since the first utterance has been removed from the list, no 1000 label is found. As a result, block 506 is executed in which the label 1001 is found. If “1001” had not been found, processing would continue to block 509 in which would lead to search for and processing of labels 2000, 3000, etc. Since the 1001 label has been found, in block 507, the variable audio_ends is saved and set equal to the starting alignment 406 of the word “to”. The audio segment from audio_start to audio_end is saved in the audio file “new_name” in block 510 Having processed a complete bracketing sequence of utterances, the process can terminate in block 511 permitting the execution of application software that can make use of the decoded utterance as a command and the extracted audio as data.

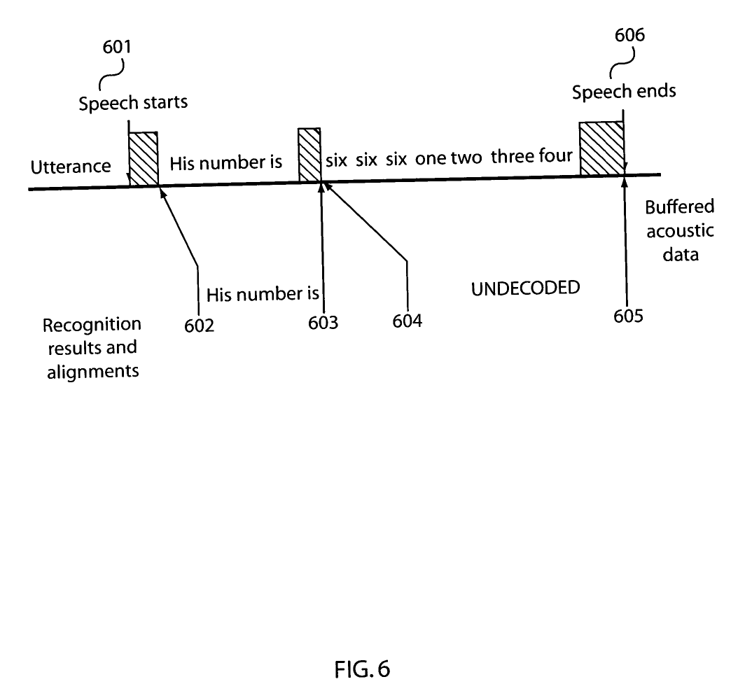

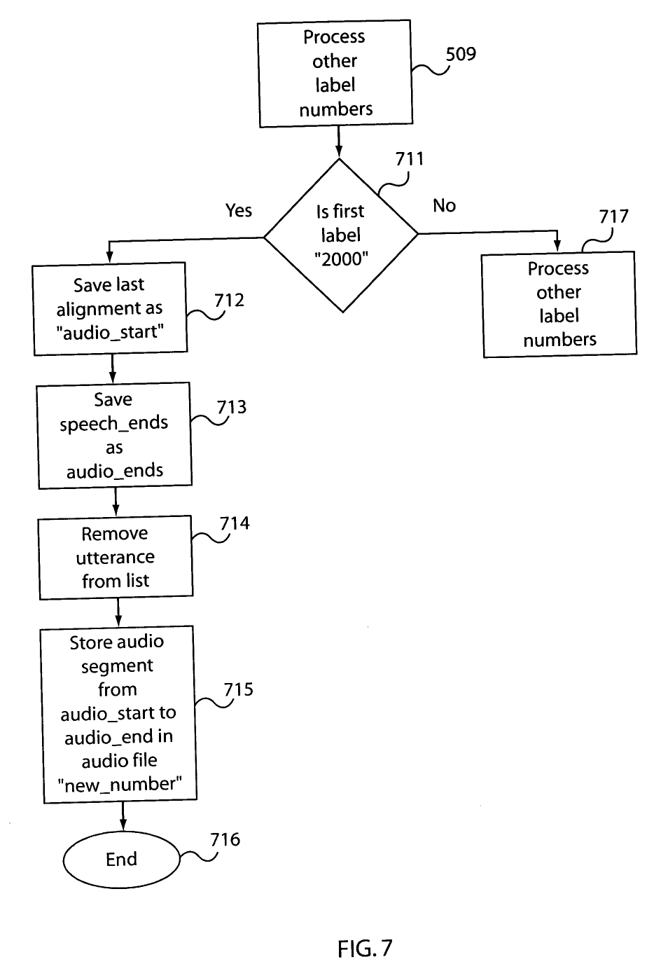

Continuing with our example, “Add Jack Smith to my phone book. His number is six six six, one two three four”, the second part of the utterance might be decoded as shown in FIG. 6 and described below with reference to FIG. 7.

In FIG. 6, speech starts at 601 and ends at 606. Speech data between times 602 and 603 are decodable, while the numbers between times 604 and 605 are undecoded.

Referring to FIG. 7, application software, having received a message which is understood as including part of the information needed to add a new telephone number to an address book may now return the thread of execution to a software program illustratively shown in FIG. 7. Since the next utterance does not include either the label 1000 or the label 1001, processing shown in FIG. 5 results in the program executing the “No” branches at 503 and at 506, thus arriving at the test 711 (graphically via connector 509). Since the decoded utterance does include the label “2000” the yes branch is executed from block 711. If it had not been found, processing would continue to block 717, which would lead to searching for and processing label 3000.

The “Yes” branch from block 711 proceeds by first setting the audio_start variable equal to the end alignment of the labeled word “is” in block 712. The path continues by setting the audio_end variable equal to the speech ends time value (606) in block 713. Then, the subject sentence is removed from the list in block 714, and the audio segment delineated by audio_start and audio_end is stored in an audio file named “new_number” in block 715. Having processed a completed a sequence bracketed at the start by an utterance and at the end by a speech_ends (microphone off) time marker, the process can terminate in block 716 permitting the execution of application software that can make use of the decoded utterance as a command and the extracted audio as data. In this case, the application, understanding that the audio is most likely to include a sequence of numbers, can load a recognition vocabulary defined by a BNF as shown in case 3 below. Such a limited vocabulary greatly increases the accuracy of recognition.

Following decoding the number utterance and subsequent processing by the application, the default vocabulary can be reinstated by function calls made by the application. Case 3 shows an exemplary application for recognizing and decoding a sequence of numbers.

Case 3:

<root> = <extension> | <local_number> | <long_distance>.
<extension> = <number><number><number><number>.
<local_number> = <number><number><number><extension>.
<long_distance>= <number><number><number><local_number>.
<number> = one | two | three | four | five | six | seven |
eight | nine | zero.

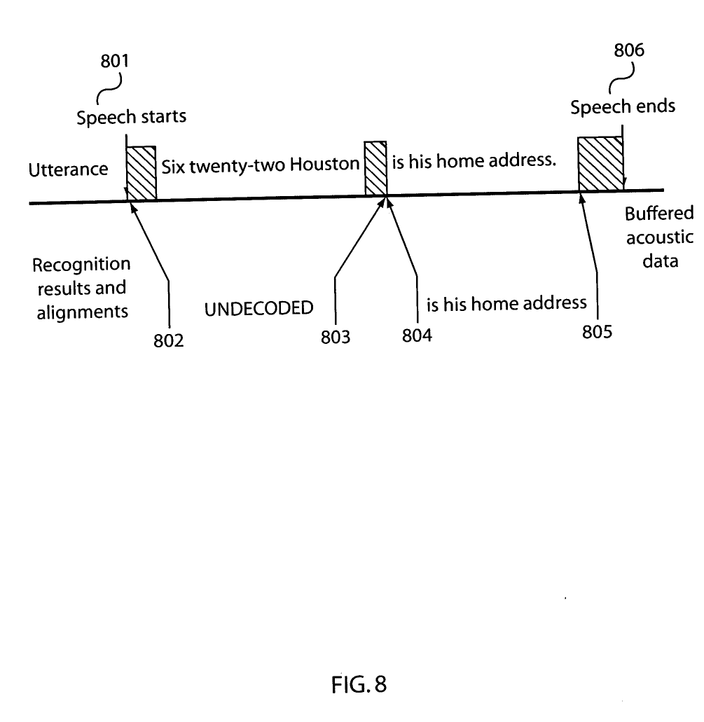

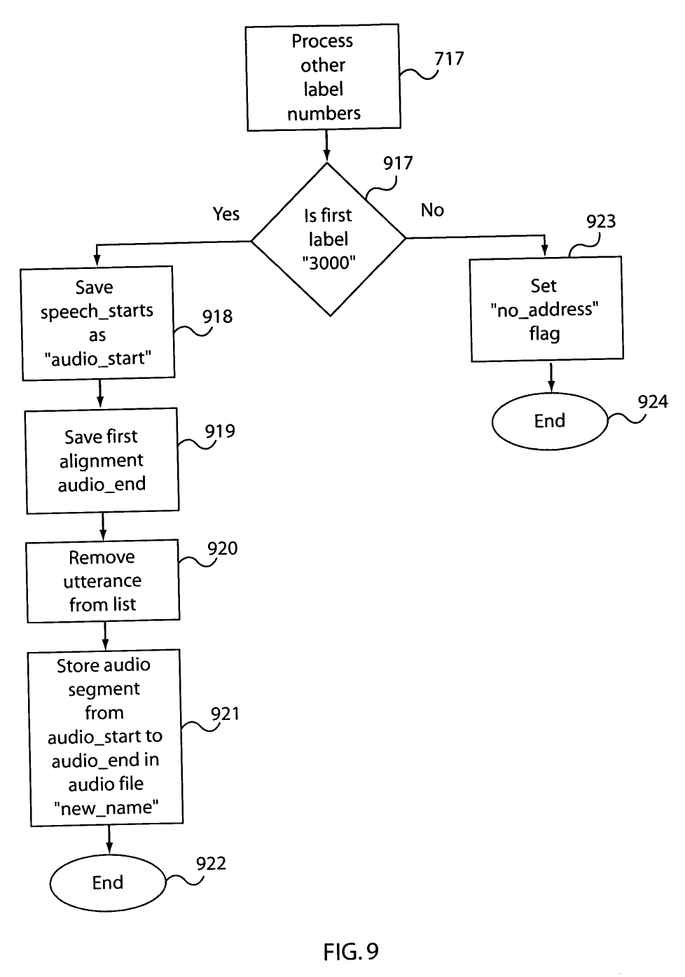

Continuing with the telephone example, the application developer may cause a prompt to be given to the user to the permit additional information to be added, for example, an address. In the case where no address is available or none is needed, the vocabulary may permit the user to answer simply “No” or “No address”. The user may be allowed to enter the address using an utterance that is audio data followed by a “command”. The utterance shown in FIG. 8 illustratively shows the address utterance “Six twenty-two Houston is his home address”. The grammar for managing this utterance is illustratively shown in case 4 below.

Case 4:

<root> = No address? | is:3000 his <address_type> address
<address_type> = home | work | shipping

If the decoded speech included no labels, as in the case of “No” or “No address”, this fact could be used to skip the optional step of associating an address with the telephone number. If, on the other hand, the decoded utterance did include a label, it could be processed as shown in FIG. 9.

Referring to FIGS. 8 and 9, application software, having received a message, which it understands as including information needed to add a new telephone number to an address book may now return the thread of execution to the software previously described to obtain an optional address. Since the next utterance does not include the labels 1000, 1001 or 2000, processing shown in FIG. 5 results in the program executing the “No” branches at 503 (FIG. 5), 506 (FIG. 5), and 711 (FIG. 7), thus arriving at the test 917 (via block 717). Since the decoded utterance includes the label “3000”, the yes branch is executed. If it had not been found, processing would continue to block 923, which would set a flag to indicate that no optional address data had been found and then ending execution in block 924.

The “Yes” branch proceeds by first setting the audio_start variable equal to the speech starts time 801 value in block 918, and the audio_end variable is set equal to the starting time alignment 802 in block 919. Then, the subject sentence is removed from the list in block 920. In block 921, the audio segment delineated by audio_start and audio_end is stored in an audio file named “new_address”. Having processed a completed a sequence bracketed at the start by a speech starts 801 (microphone on) time marker and at the end 806 by an utterance, the process can terminate in block 922 permitting the execution of application software that can make use of the decoded utterance as a command and the extracted audio as data.

In this case, the application, understanding that the audio is most likely to include a name and numbers, can store this information as audio data until such time as large vocabulary recognition resources are available or the user replaces the audio data by spelling or typing the data.

Although creating telephone book entries has been used as an example in the exemplary embodiments described, the systems and methods described for dividing utterances into command and data segments may be applied to a wide variety of spoken language user interface problems without departing from the spirit and scope of the present invention. Such systems and methods may include highly complex program paths and large numbers of commands and label indexes to handle any type of system complexity.

Other aspects of exemplary embodiments may include a mechanism which permits updating of the spelling of acoustic add words at a later time by submitting the acoustic data to a large vocabulary speech recognizer and asking the user if a recognition result correct and/or updating the associated text data field. In an alternate embodiment, a user may be prompted to spell the word included in the acoustic data. In other embodiments, the acoustic sample may be trimmed to reduce silence portions of the utterance.

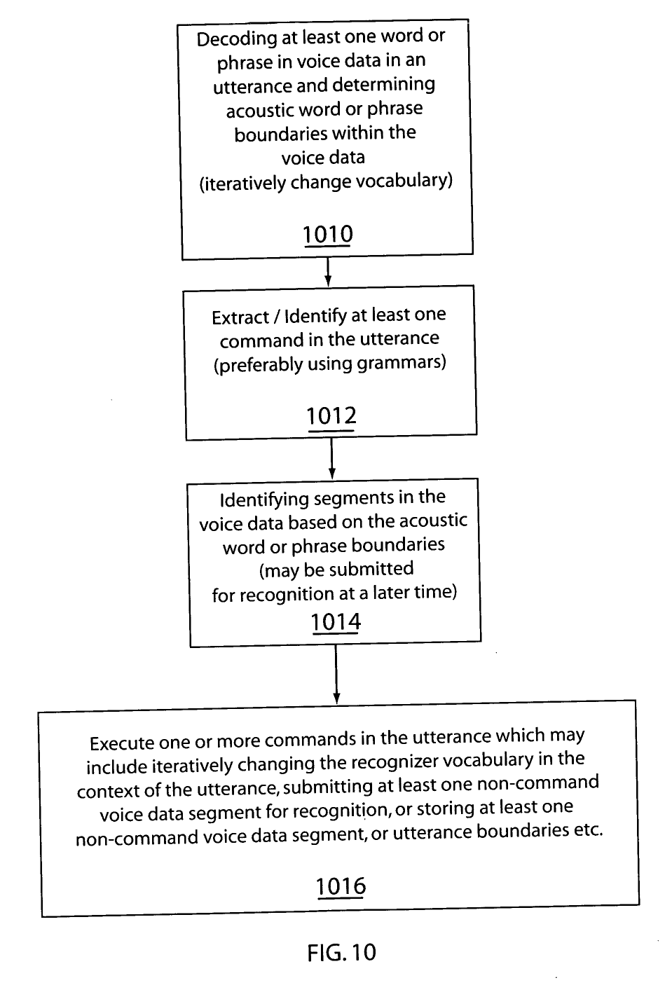

Referring to FIG. 10, a block/flow diagram for illustrative embodiments for a method for recognizing at least one command and at least one segment of acoustic voice data in a same utterance is shown. In block 1010, decoding at least one word or phrase in voice data representing an acoustic signal that comprises a human utterance is performed. The acoustic word boundaries are determined within the voice data. In block 1012, at least one command is identified in the utterance. This may include employing one or more grammars to decipher the commands. Grammar labels may be associated with the corresponding segment of voice data that has been decoded into a command. The label preferably includes a numerical value associated with each command.

In block 1014, segments in the voice data are identified based on the acoustic word or phrase boundaries. These segments may be decoded at a later time, for example, when a more complete vocabulary is available or when larger computing resources become available for an intermittently connected device.

In block 1016, the one or more commands in the utterance are executed to perform an action. The action may include one or more of: calling a specialized vocabulary, such as a number vocabulary to decode voice data, extracting acoustic data as to create a training model or to simply save the actual acoustic data or a decoded version of it for different applications. Executing the at least one command in the utterance may include changing the recognizer vocabulary, submitting at least one non-command voice data segment for recognition, storing at least one non-command voice data segment or performing other actions.

The extraction of acoustic data is based on the command word or phrase acoustic boundaries. A given acoustic segment may be stored as acoustic data between boundaries of the command segment. The stored acoustic data may be decoded at a later time when other resources are available, for example. The execution of commands may include extracting acoustic data based on word or phrase boundaries. The steps shown in FIG. 10 may include iteratively finding segment boundaries in the utterance. These boundaries may be found by using a combination of grammars and, if necessary, by changing, in the context of the utterance, grammars which are applied against the same utterance. In other words, one or more vocabularies may be iteratively applied against the same utterance to determine the command and/or the acoustic data portions of the utterance or to assist in the execution of a command.

Having described preferred embodiments for dissection of utterances into commands and voice data (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A method for extracting commands and acoustic data in a same utterance, comprising the steps of:
decoding at least one word in acoustic data representing an acoustic signal that comprises a human utterance and determining acoustic word boundaries within the acoustic data;
extracting at least one command in a decoded utterance; and
identifying acoustic data segments in the utterance based on the acoustic word boundaries.

2. The method as recited in claim 1, wherein the step of determining acoustic word boundaries includes finding segment boundaries by iteratively comparing the same utterance to a plurality of vocabularies.

3. The method as recited in claim 1, further comprising the step of executing the at least one command from the decoded utterance.

4. The method as recited in claim 3, further comprising at least one of storing the acoustic data segments and using the acoustic data segments in executing the at least one command.

5. The method as recited in claim 3, further comprising the step of submitting at least one non-command voice data segment for recognition using the recognizer vocabulary.

6. The method as recited in claim 1, further comprising the step of changing a recognizer vocabulary.

7. The method as recited in claim 1, further comprising the step of submitting the acoustic data segments for recognition when computing resources are available.

8. The method as recited in claim 1, wherein the step of extracting at least one command from the utterance includes employing one or more grammars to distinguish the command.

9. The method as recited in claim 8, wherein the grammars include a form for extracting information for an order or verbal contract.

10. The method as recited in claim 8, wherein the grammars include a form for reminding a user to perform a task.

11. The method as recited in claim 8, wherein the grammars include a form for extracting maximum meaningful length segments under interruption or silence conditions.

12. The method as recited in claim 8, wherein the step of using grammars includes the step of associating at least one grammar label with the corresponding segment of acoustic data that has been decoded into a command.

13. The method as recited in claim 12, wherein the label includes a numerical value associated with each command.

14. The method as recited in claim 1, further comprising the step of executing the at least command in the utterance using undecoded acoustic data from within the same utterance.

15. A program storage device readable by machine, tangibly embodying a program of instructions executable by the machine to perform method steps for processing commands and voice data in a same utterance as recited in claim 1.

16. A method for recognizing at least one command and at least one segment of acoustic voice data in a same utterance comprising the steps of:
decoding at least one word in voice data representing the acoustic signal that comprises a human utterance and determining the acoustic word boundaries within the voice data;
extracting at least one command from the utterance;
associating segments in the voice data based on the acoustic word boundaries with labels.

17. The method as recited in claim 16, wherein the step of extracting includes employing an application, which identifies commands in the utterance in accordance with the labels.

18. The method as recited in claim 16, further comprising the step of executing the at least one command utilizing undecoded information in the acoustic voice data.

19. The method as recited in claim 16, wherein the step of extracting includes the step of storing at least one non-command voice data segment.

20. The method as recited in claim 16, wherein the step of extracting includes calling a vocabulary for recognizing numbers and recognizing the numbers in the utterance.

21. The method as recited in claim 16, wherein the step of extracting includes extracting acoustic data based on word boundaries and saving the acoustic data for acoustically rendering the acoustic data.

22. The method as recited in claim 16, wherein the step of extracting includes extracting acoustic data based on word boundaries and decoding the acoustic data for storage.

23. The method as recited in claim 16, wherein the step of associating includes the step of changing a recognizer vocabulary and submitting at least one non-command voice data segment for recognition.

24. The method as recited in claim 16, further comprising the step of buffering the utterance to be processed and maintaining the utterance in memory during processing of the utterance.

25. The method as recited in claim 16, wherein the step of associating time segments of the word boundaries of the commands with a label includes employing grammars to associate a unique label with each command segment in the utterance.

26. The method as recited in claim 25, wherein the label includes a numerical value.

27. The method as recited in claim 25, wherein the grammars include a form for extracting information for an order or verbal contract.

28. The method as recited in claim 25, wherein the grammars include a form for reminding a user to perform a task.

29. The method as recited in claim 25, wherein the grammars include a form for extracting maximum meaningful length segments under interruption or silence conditions.

30. The method as recited in claim 16, wherein the step of determining the acoustic word boundaries includes finding segment boundaries by iteratively comparing the same utterance to a plurality of vocabularies.

31. A program storage device readable by machine, tangibly embodying a program of instructions executable by the machine to perform method steps for recognizing commands and voice data in a same utterance as recited in claim 16.

32. A system for recognizing commands and voice data in a same utterance comprising:
an acoustic input, which receives utterances;
a data buffer, which stores audio data representing the utterances;
a speech recognition engine, which matches portions of the utterances to acoustic models and language models to recognize words and word boundaries in the utterance and labels commands in the utterance;
at least one program that executes label-identified commands and processes remaining portions of the utterance in accordance with the commands.

33. The system as recited in claim 32, wherein the at least one program includes a function which searches the utterance for labels output from the speech recognition engine to execute a command associated with the label.

34. The system as recited in claim 32, wherein, in accordance with each label, an audio segment is identified and processed.

35. The system as recited in claim 32, wherein the speech recognition engine utilizes grammars with labels, which the system uses for assigning labels to decoded commands.

36. The system as recited in claim 35, wherein the grammars are represented in Bachus-Naur Form (BNF).
